(19) United States
(12) Patent Application Publication
(10) Pub. No.: US 2024/0349020 A1
(43) Pub. Date: Oct. 17, 2024

(54) SYSTEMS AND METHODS FOR LIVE EVENT AUDIENCE GROUP COMMUNICATION

(71) Applicant: Mixhalo Corp., San Francisco, CA (US)

(72) Inventor: John Denton Vars, San Francisco, CA (US)

(21) Appl. No.: 18/632,798

(22) Filed: Apr. 11, 2024

Related U.S. Application Data
(60) Provisional application No. 63/458,818, filed on Apr. 12, 2023.

(51) Int. Cl. H04W 4/30; G06F 3/16

(52) U.S. Cl. CPC H04W 4/30; G06F 3/165

(57) ABSTRACT

A method for real-time voice communication between mobile computing devices at a live event includes receiving a data representation of a live audio signal corresponding to the live event by a first mobile computing device via a wireless network. The method also includes processing the data representation of the live audio signal into a live audio stream. The method also includes initiating playback of the live audio stream via a headphone communicatively coupled to the first mobile computing device at the live event. The method also includes detecting a voice audio signal via a microphone communicatively coupled to the first mobile computing device at the live event. The method also includes adjusting a volume of the playback of the live audio stream to a decreased volume. The method also includes transmitting the voice audio signal to a second mobile computing device at the live event via the wireless network.

### RELATED APPLICATION(S)

This application claims priority to U.S. Provisional Patent Application No. 63/458,818, filed Apr. 12, 2023, the entirety of which is incorporated herein by reference.

### TECHNICAL FIELD

This invention relates generally to the field of real-time delivery of data over wireless networks. More specifically, the invention relates to systems and methods for real-time voice communication between mobile devices at a live event.

### BACKGROUND

Audience members at live events often have difficulty talking with each other due to the volume of the live event audio. Generally, audience members bring their mobile devices to live events, allowing them to communicate with each other via text messaging services. However, using text messaging services at live events can be distracting because they force the user to look away from the entertainment being presented at the live event and, instead, focus on typing a message on a mobile device. Therefore, there is a need for systems and methods that allow audience members at live events to communicate with each with minimal impact on the enjoyment of the entertainment being presented at the live event.

### SUMMARY

The present invention includes systems and methods for real-time voice communication between mobile computing devices. For example, the present invention includes systems and methods for receiving a data representation of a live audio signal corresponding to a live event via a wireless network and processing the data representation of the live audio signal into a live audio stream. The present invention also includes systems and methods for initiating playback of the live audio stream via a headphone communicatively coupled to a mobile computing device at the live event. The present invention also includes systems and methods for detecting a voice audio signal via a microphone of the mobile computing device at the live event. The present invention also includes systems and methods for adjusting a volume of playback of the live audio stream to a decreased volume in response to detecting the voice audio signal. The present invention also includes systems and methods for transmitting and receiving the voice audio signal to and from mobile computing devices at the live event via the wireless network.

In one aspect, the invention includes a computerized method for real-time voice communication between mobile computing devices at a live event. The computerized method includes receiving, by a first mobile computing device at a live event, a data representation of a live audio signal corresponding to the live event via a wireless network. The computerized method also includes processing, by the first mobile computing device at the live event, the data representation of the live audio signal into a live audio stream. The computerized method also includes initiating, by the first mobile computing device at the live event, playback of the live audio stream via a headphone communicatively coupled to the first mobile computing device at the live event.

The computerized method also includes detecting, by the first mobile computing device at the live event, a voice audio signal via a microphone of the first mobile computing device at the live event. The computerized method also includes, in response to detecting the voice audio signal, adjusting, by the first mobile computing device at the live event, a volume of the playback of the live audio stream to a decreased volume. The computerized method also includes transmitting, by the first mobile computing device at the live event, the voice audio signal to a second mobile computing device at the live event via the wireless network.

In some embodiments, the first mobile computing device is configured to receive the data representation of the live audio signal corresponding to the live event from an audio server computing device via the wireless network.

In some embodiments, the computerized method further includes detecting, by the first mobile computing device at the live event, a cessation of the voice audio signal via the microphone of the first mobile computing device at the live event. For example, in some embodiments, in response to detecting the cessation of the voice audio signal, the computerized method further includes adjusting, by the first mobile computing device at the live event, the volume of the playback of the live audio stream to an initial volume.

In some embodiments, the computerized method further includes transmitting, by the first mobile computing device at the live event, the voice audio signal to a third mobile computing device at the live event via the wireless network. In some embodiments, the computerized method further includes transmitting, by the first mobile computing device at the live event, the voice audio signal to a fourth mobile computing device outside of a geographical area corresponding to the live event.

In another aspect, the invention includes a computerized method for real-time voice communication between mobile computing devices at a live event. The computerized method includes receiving, by a first mobile computing device at a live event, a data representation of a live audio signal corresponding to the live event via a wireless network. The computerized method also includes processing, by the first mobile computing device at the live event, the data representation of the live audio signal into a live audio stream. The computerized method also includes initiating, by the first mobile computing device at the live event, playback of the live audio stream via a headphone communicatively coupled to the first mobile computing device at the live event.

The computerized method also includes receiving, by the first mobile computing device at the live event, a voice audio signal from a second mobile computing device at the live event via the wireless network. The computerized method also includes, in response to receiving the voice audio signal, adjusting, by the first mobile computing device at the live event, a volume of the playback of the live audio stream to a decreased volume. The computerized method also includes initiating, by the first mobile computing device at the live event, playback of the voice audio signal via the headphone communicatively coupled to the first mobile computing device at the live event.

In some embodiments, the first mobile computing device is configured to receive the data representation of the live audio signal corresponding to the live event from an audio server computing device via the wireless network.

In some embodiments, the computerized method further includes detecting, by the first mobile computing device at the live event, a cessation of the voice audio signal via the wireless network. For example, in some embodiments, the computerized method further includes, in response to detecting the cessation of the voice audio signal, adjusting, by the first mobile computing device at the live event, the volume of the playback of the live audio stream to an initial volume.

In another aspect, the invention includes a system for real-time voice communication between mobile computing devices at a live event. The system includes a first mobile computing device communicatively coupled to a second mobile computing device over a wireless network. The first mobile computing device is configured to receive a first data representation of a live audio signal corresponding to the live event via the wireless network. The first mobile computing device is also configured to process the first data representation of the live audio signal into a live audio stream. The first mobile computing device is also configured to initiate playback of the live audio stream via a first headphone communicatively coupled to the first mobile computing device at the live event.

The first mobile computing device is also configured to detect a first voice audio signal via a microphone of the first mobile computing device at the live event. The first mobile computing device is also configured to, in response to detecting the first voice audio signal, adjust a first volume of the playback of the live audio stream to a decreased volume. The first mobile computing device is also configured to transmit the first voice audio signal to the second mobile computing device at the live event via the wireless network.

The second mobile computing device is configured to receive a second data representation of the live audio signal corresponding to the live event via the wireless network. The second mobile computing device is also configured to process the second data representation of the live audio signal into the live audio stream. The second mobile computing device is also configured to initiate playback of the live audio stream via a second headphone communicatively coupled to the second mobile computing device at the live event.

The second mobile computing device is also configured to receive the first voice audio signal from the first mobile computing device at the live event via the wireless network. The second mobile computing device is also configured to, in response to receiving the first voice audio signal, adjust a second volume of the playback of the live audio stream to the decreased volume. The second mobile computing device is also configured to initiate playback of the first voice audio signal via the second headphone communicatively coupled to the second mobile computing device at the live event.

In some embodiments, the first mobile computing device is configured to receive the first data representation of the live audio signal corresponding to the live event from an audio server computing device via the wireless network and the second mobile computing device is configured to receive the second data representation of the live audio signal corresponding to the live event from the audio server computing device via the wireless network.

In some embodiments, the first mobile computing device is further configured to detect a cessation of the first voice audio signal via the microphone of the first mobile computing device at the live event. For example, in some embodiments, the first mobile computing device is further configured to, in response to detecting the cessation of the first voice audio signal, adjust the first volume of the playback of the live audio stream to an initial volume.

In some embodiments, the first mobile computing device is further configured to transmit the first voice audio signal to a third mobile computing device at the live event via the wireless network. In some embodiments, the first mobile computing device is further configured to transmit the first voice audio signal to a fourth mobile computing device outside of a geographical area corresponding to the live event.

In some embodiments, the second mobile computing device is further configured to detect a cessation of the first voice audio signal via the wireless network. For example, in some embodiments the second mobile computing device is further configured to, in response to detecting the cessation of the first voice audio signal, adjust the second volume of the playback of the live audio stream to the initial volume.

In some embodiments, the second mobile computing device is further configured to receive a second voice audio signal from a third mobile computing device at the live event via the wireless network. In some embodiments, the second mobile computing device is further configured to receive a second voice audio signal from a fourth mobile computing device outside of a geographical area corresponding to the live event.

These and other aspects of the invention will be more readily understood from the following descriptions of the invention, when taken in conjunction with the accompanying drawings and claims.

### BRIEF DESCRIPTION OF THE DRAWINGS

FIG. 1 is a schematic diagram of a system architecture for real-time delivery of data over wireless networks, according to an illustrative embodiment of the invention.

FIG. 2 is a schematic flow diagram illustrating real-time voice communication between mobile computing devices at a live event using the system architecture of FIG. 1, according to an illustrative embodiment of the invention.

FIG. 3 is a schematic flow diagram illustrating real-time voice communication between mobile computing devices at a live event using the system architecture of FIG. 1, according to an illustrative embodiment of the invention.

### DETAILED DESCRIPTION

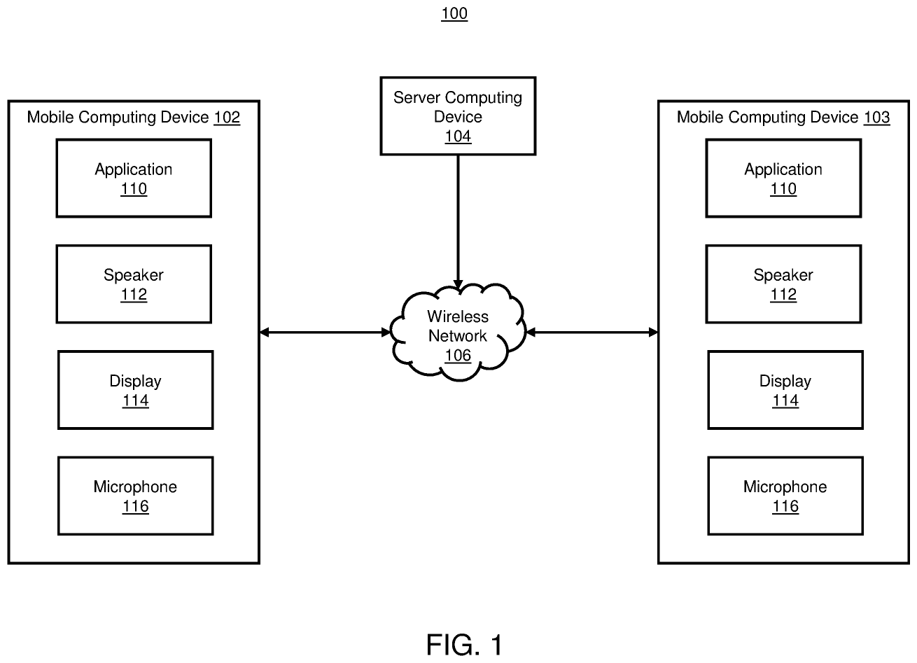

FIG. 1 is a schematic diagram of a system architecture 100 for real-time delivery of data over wireless networks, according to an illustrative embodiment of the invention. System 100 includes one or more mobile computing devices 102, 103 communicatively coupled to a server computing device 104 over a wireless network 106. Mobile computing devices 102, 103 include an application 110, one or more speakers 112, a display 114, and one or more microphones 116. In some embodiments, server computing device 104 comprises an audio server computing device which is communicatively coupled to an audio interface (not shown).

Exemplary mobile computing devices 102, 103 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts two mobile computing devices 102, 103, it should be appreciated that system 100 can include any number of mobile computing devices.

System 100 can be configured for real-time voice communication between mobile computing devices 102, 103 at a live event. For example, system 100 can include a first mobile computing device 102 communicatively coupled to a second mobile computing device 103 over wireless network 106. The first mobile computing device 102 is configured to receive a first data representation of a live audio signal corresponding to the live event via the wireless network 106. In some embodiments, users of the mobile computing devices 102, 103 activate the application 110 on their respective devices in order to establish a connection for real-time voice communication via wireless network 106. In some embodiments, application 110 also communicates via wireless network 106 with server computing device 104 to receive the first data representation of the live audio signal corresponding to the live event and application 110 processes the first data representation of the live audio signal into a live audio stream. An exemplary application 110 can be an app downloaded to and installed on the mobile computing device 102 via, e.g., the Apple® App Store or the Google® Play Store. A user can launch application 110 on the first mobile computing device 102 and interact with one or more user interface elements displayed by the application 110 on a screen of the first mobile computing device 102 to initiate the receipt and processing of the data representation of the live audio signal, and to establish a connection for real-time voice communication with one or more other mobile computing devices (such as device 103) at the live event.

The first mobile computing device 102 is also configured to initiate playback of the live audio stream via a first headphone (not shown) communicatively coupled to the first mobile computing device 102 at the live event. For example, the user of first mobile computing device 102 can connect a headphone to the device via a wired connection (e.g., by plugging the headphone into a jack on the mobile computing device) or via a wireless connection (e.g., pairing the headphone to the mobile computing device via a short-range communication protocol such as Bluetooth™). The first mobile computing device 102 can then initiate playback of the live audio stream via the headphone.

The first mobile computing device 102 is also configured to detect a first voice audio signal via a microphone 116 of the first mobile computing device 102 at the live event. In some embodiments, application 110 is configured to capture audio via the microphone 116 and analyze the captured audio to detect the first voice audio signal. For example, application 110 can analyze the captured audio to filter out signals that are not indicative of the first voice audio signal (e.g., crowd noise, background noise, music) and to detect signals that are indicative of the first voice audio signal. In some embodiments, application 110 can use voice activity detection (VAD) techniques to detect the first voice audio signal, as described in J. Ball, “Voice Activity Detection (VAD) in Noisy Environments,” arXiv: 2312.05815v1 [cs.SD] 10 Dec. 2023, available at arxiv.org/pdf/2312.05815.pdf, which is incorporated herein by reference. In some configurations, the headphone coupled to the first mobile computing device 102 may include a microphone (in addition to microphone 116) that can be configured to capture audio for detecting the first voice audio signal.

The first mobile computing device 102 is also configured to, in response to detecting the first voice audio signal, adjust a first volume of the playback of the live audio stream to a decreased volume. For example, upon detecting the first voice audio signal as described above, application 110 automatically decreases an initial playback volume of the live audio stream to a predetermined level and begins capturing the first voice audio signal. In some embodiments, the user of the first mobile computing device 102 (who is listening via the headphone) can hear the first voice audio signal as it is being captured by microphone 116. In these embodiments, a playback volume of the captured voice audio signal is set so that the user hears the voice audio at a higher volume in addition to the live audio stream at a decreased volume. Also, application 110 can be configured to detect and transcribe speech in the captured voice audio signal in real-time and generate one or more messages for display on the first mobile computing device 102 that comprise the transcribed speech (e.g., a chat-based feature). In some embodiments, the transcribed speech messages can be stored on first mobile computing device 102 and/or transmitted to a remote computing device (such as a social media network) along with images and/or video captured by the mobile computing device 102. The first mobile computing device 102 is also configured to transmit the first voice audio signal to the second mobile computing device 103 at the live event via the wireless network 106. In some embodiments, the transcribed speech messages can also be transmitted to the second mobile computing device 103 via the wireless network 106.

In some embodiments, the first mobile computing device 102 is further configured to detect a cessation of the first voice audio signal via the microphone 116 of the first mobile computing device 102 at the live event. For example, application 110 can determine that the user of the first mobile computing device 102 has finished speaking into the microphone 116, e.g., by using the VAD techniques described above. In some embodiments, the first mobile computing device 102 is further configured to, in response to detecting the cessation of the first voice audio signal, adjust the first volume of the playback of the live audio stream back to the initial volume.

In some embodiments, the first mobile computing device 102 is further configured to transmit the first voice audio signal to a third mobile computing device (not shown) at the live event via the wireless network 106. In some embodiments, the first mobile computing device 102 is further configured to transmit the first voice audio signal to a fourth mobile computing device (not shown) outside of a geographical area corresponding to the live event. For example, the first mobile computing device 102 can utilize the wireless network 106 to connect to the Internet, or utilize one or more other networks (e.g., cellular) apart from the wireless network 106, to transmit the first voice audio signal to the fourth mobile computing device.

Like the operation of the first mobile computing device 102 as described above, the second mobile computing device 103 at the live event can be configured to receive a second data representation of the live audio signal corresponding to the live event via the wireless network 106. The second mobile computing device 103 is also configured to process the second data representation of the live audio signal into the live audio stream. The second mobile computing device 103 is also configured to initiate playback of the live audio stream via a second headphone (not shown) communicatively coupled to the second mobile computing device 103 at the live event.

In some embodiments, the second mobile computing device 103 can establish a connection for real-time voice communication via wireless network 106 to the first mobile computing device 102 (e.g., using application 110). For example, application 110 can be configured to detect nearby mobile computing devices on which application 110 is installed and active and display a list of such devices to the user of the second mobile computing device 103. The user can then select a mobile computing device from the list in order to establish a connection for real-time voice communication. In some embodiments, the users of mobile computing devices 102, 103 may have previously connected their devices and application 110 can save this information in order to automatically connect the devices during the live event.

The second mobile computing device 103 is also configured to receive the first voice audio signal from the first mobile computing device 103 at the live event via the wireless network 106. The second mobile computing device 103 is also configured to, in response to receiving the first voice audio signal, adjust a second volume of the playback of the live audio stream to the decreased volume. The second mobile computing device 103 is also configured to initiate playback of the first voice audio signal via the second headphone (not shown) communicatively coupled to the second mobile computing device 102 at the live event. In some embodiments, each of the live audio stream and the voice audio signal is received by application 110 of the second mobile computing device 103 as a separate channel, and a user of the second mobile computing device 103 can adjust a relative volume of each channel to produce an audio mix that comprises both the live audio stream and the voice audio signal according to the relative volume settings. For example, the application 110 can display a slider or knob to the user, with an indicator set to a middle position (indicating an equally balanced mix between the live audio stream and the voice audio signal). When the user adjusts the indicator in one direction (e.g., left), the application 110 can increase the relative volume of the live audio stream and reduce the relative volume of the voice audio signal. Similarly, when the user adjusts the indicator in the other direction (e.g., right), the application 110 can increase the relative volume of the voice audio signal and decrease the relative volume of the live audio stream. As mentioned above, in some embodiments, the second mobile computing device 103 can optionally receive the transcribed speech messages from the first mobile computing device 102 and display the messages to the user of the second device 103.

In some embodiments, the first mobile computing device 102 is configured to receive the first data representation of the live audio signal corresponding to the live event from the server computing device 104 via the wireless network 106 and the second mobile computing device 102 is configured to receive the second data representation of the live audio signal corresponding to the live event from the server computing device 104 via the wireless network 106.

In some embodiments, the second mobile computing device 102 is further configured to detect a cessation of the first voice audio signal via the wireless network 106. For example, in some embodiments the second mobile computing device 102 is further configured to, in response to detecting the cessation of the first voice audio signal, adjust the second volume of the playback of the live audio stream to the initial volume.

In some embodiments, the second mobile computing device 102 is further configured to receive a second voice audio signal from a third mobile computing device (not shown) at the live event via the wireless network 106. In some embodiments, the second mobile computing device 102 is further configured to receive a second voice audio signal from a fourth mobile computing device (not shown) outside of a geographical area corresponding to the live event.

Thus, as can be appreciated, the techniques described herein enable real-time voice communication between two or more mobile computing devices 102, 103 at a live event while also providing for high-quality audio playback on the mobile devices during the live event.

Server 104 is a computing device comprising specialized hardware and/or software modules that execute on one or more processors and interact with memory modules of the audio server computing device, to receive data from other components of the system 100, transmit data to other components of the system 100, and perform functions relating to transmission of a data representation of a live audio signal to mobile computing devices 102 at a live event as described herein. In some embodiments, server 104 is an audio server computing device 104 configured to receive a live audio signal from an audio source at the live event (e.g., a soundboard that is capturing the live audio) and transmit a data representation of the live audio signal via network 106 to one or more mobile computing devices 102.

In some embodiments, server computing device 104 can pre-process the live audio signal when generating the data representation of the live audio signal prior to transmission to mobile computing devices. For example, the server computing device 104 can generate one or more data packets corresponding to the live audio signal. In some embodiments, creating a data representation of the live audio signal includes using one of the following compression codecs: AAC, HE-AAC MP3, MPE VBR, Apple Lossless, IMA4, IMA ADPCM, or Opus.

Wireless network 106 is configured to communicate electronically with network hardware of the server computing device 104 and to transmit the data representation of the live audio signal to the mobile computing devices 102. Wireless network 106 is also configured to communicate electronically with network hardware of the mobile computing devices 102 to enable real-time voice communication between the devices 102 as described herein. In some embodiments, the network 104 can support one or more routing schemes, e.g., unicast, multicast and/or broadcast.

Additional detail regarding illustrative technical features of the methods and systems described herein are found in U.S. Pat. No. 11,461,070, titled “Systems and Methods for Providing Real-Time Audio and Data” and issued Oct. 24, 2022; U.S. Pat. No. 11,625,213, titled “Systems and Methods for Providing Real-Time Audio and Data,” and issued Apr. 11, 2023; U.S. patent application Ser. No. 18/219,778, titled “Systems and Methods for Wireless Real-Time Audio and Video Capture at a Live Event,” published as U.S. Patent Application Publication No. 2024/0022769 on Jan. 18, 2024; and U.S. patent application Ser. No. 18/219,792, titled “Systems and Methods for Wireless Real-Time Audio and Video Capture at a Live Event,” published as U.S. Patent Application Publication No. 2024/0021218 on Jan. 18, 2024; the entirety of each of which is incorporated herein by reference.

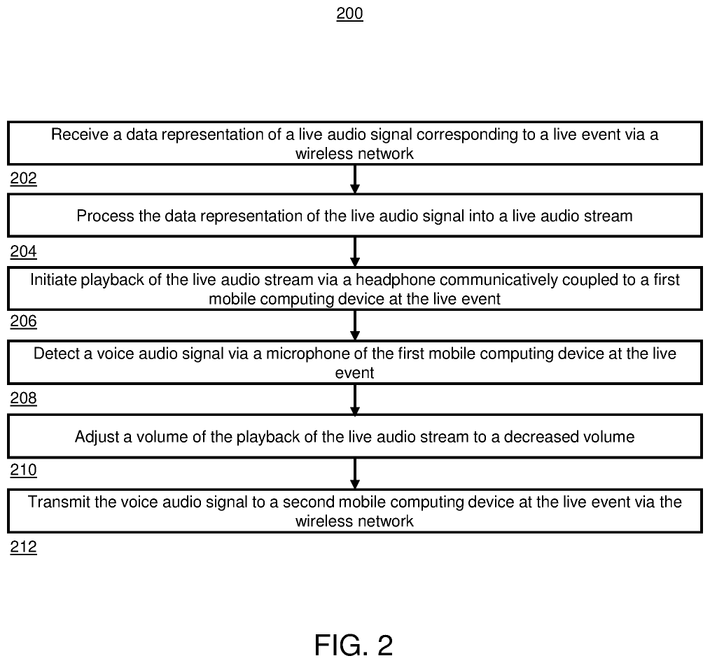

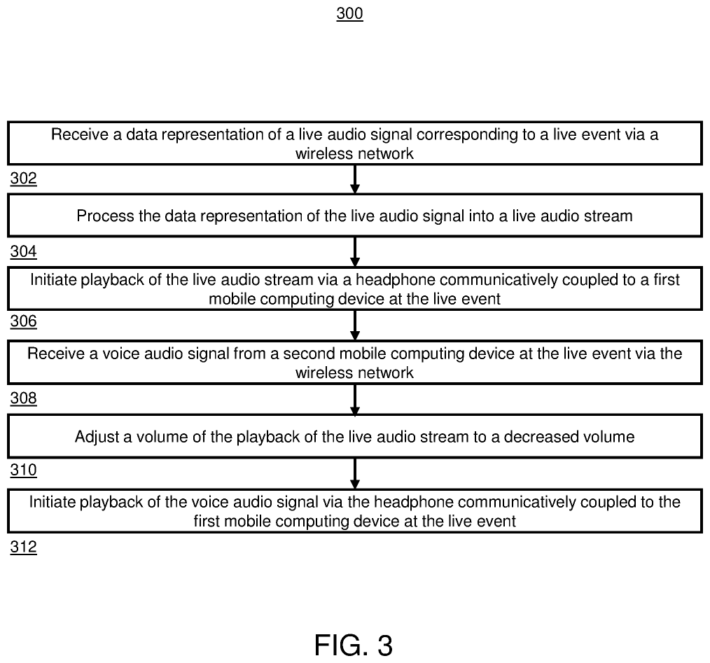

As shown in FIGS. 2 and 3, system 100 can be configured to transmit and receive, respectively, real-time voice communication between mobile computing devices at a live event. For example, process 200 begins by receiving, by a first mobile computing device 102 at a live event, a data representation of a live audio signal corresponding to the live event via a wireless network 106 at step 202. For example, in some embodiments, the first mobile computing device 102 is configured to receive the data representation of the live audio signal corresponding to the live event from an audio server computing device 104 via the wireless network 106.

Process 200 continues by processing, by the first mobile computing device 102 at the live event, the data representation of the live audio signal into a live audio stream at step 204. Process 200 continues by initiating, by the first mobile computing device 102 at the live event, playback of the live audio stream via a headphone (not shown) communicatively coupled to the first mobile computing device 102 at the live event at step 206.

Process 200 continues by detecting, by the first mobile computing device 102 at the live event, a voice audio signal via a microphone 116 of the first mobile computing device 102 at the live event at step 208. Process 200 continues by, in response to detecting the voice audio signal, adjusting, by the first mobile computing device 102 at the live event, a volume of the playback of the live audio stream to a decreased volume at step 210. Process 200 finished by transmitting, by the first mobile computing device 102 at the live event, the voice audio signal to a second mobile computing device 102 at the live event via the wireless network 106 at step 212.

In some embodiments, process 200 continues by detecting, by the first mobile computing device 102 at the live event, a cessation of the voice audio signal via the microphone 116 of the first mobile computing device 102 at the live event. For example, in some embodiments, in response to detecting the cessation of the voice audio signal, process 200 continues by adjusting, by the first mobile computing device 102 at the live event, the volume of the playback of the live audio stream to an initial volume.

In some embodiments, process 200 continues by transmitting, by the first mobile computing device 102 at the live event, the voice audio signal to a third mobile computing device 102 at the live event via the wireless network 106. In some embodiments, process 200 continues by transmitting, by the first mobile computing device 102 at the live event, the voice audio signal to a fourth mobile computing device 102 outside of a geographical area corresponding to the live event.

FIG. 3 is a schematic flow diagram of a process 300 illustrating real-time voice communication between mobile computing devices 102 at a live event using system architecture 100, according to an illustrative embodiment of the invention. Process 300 begins by receiving, by a first mobile computing device 102 at a live event, a data representation of a live audio signal corresponding to the live event via a wireless network 106 at step 302. For example, in some embodiments, the first mobile computing device 102 is configured to receive the data representation of the live audio signal corresponding to the live event from an audio server computing device 104 via the wireless network 106.

Process 300 continues by processing, by the first mobile computing device 102 at the live event, the data representation of the live audio signal into a live audio stream at step 304. Process 300 continues by initiating, by the first mobile computing device 102 at the live event, playback of the live audio stream via a headphone (not shown) communicatively coupled to the first mobile computing device 102 at the live event at step 306.

Process 300 continues by receiving, by the first mobile computing device 102 at the live event, a voice audio signal from a second mobile computing device 102 at the live event via the wireless network 106 at step 308. Process 300 continues by, in response to receiving the voice audio signal, adjusting, by the first mobile computing device 102 at the live event, a volume of the playback of the live audio stream to a decreased volume at step 310. Process 300 finishes by initiating, by the first mobile computing device 102 at the live event, playback of the voice audio signal via the headphone (not shown) communicatively coupled to the first mobile computing device 102 at the live event at step 312.

In some embodiments, process 300 continues by detecting, by the first mobile computing device 102 at the live event, a cessation of the voice audio signal via the wireless network 106. For example, in some embodiments, process 300 continues by, in response to detecting the cessation of the voice audio signal, adjusting, by the first mobile computing device 102 at the live event, the volume of the playback of the live audio stream to an initial volume.

In some embodiments, process 300 continues by receiving, by the first mobile computing device 102 at the live event, a second voice audio signal from a third mobile computing device 102 at the live event via the wireless network 106. In some embodiments, process 300 continues by receiving, by the first mobile computing device 102 at the live event, a second voice audio signal from a fourth mobile computing device 102 outside of a geographical area corresponding to the live event.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account-which allows access to the computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific preferred embodiments, it should be understood by those skilled in the art that various changes in form and detail may be made therein without departing from the spirit and scope of the invention as defined by the following claims. One skilled in the art will realize the subject matter may be embodied in other specific forms without departing from the spirit or essential characteristics thereof. The foregoing embodiments are therefore to be considered in all respects illustrative rather than limiting the subject matter described herein.

What is claimed is:

1. A computerized method for real-time voice communication between a plurality of mobile computing devices at a live event, the method comprising:
receiving, by a first mobile computing device at a live event, a data representation of a live audio signal corresponding to the live event via a wireless network;
processing, by the first mobile computing device at the live event, the data representation of the live audio signal into a live audio stream;
initiating, by the first mobile computing device at the live event, playback of the live audio stream via a headphone communicatively coupled to the first mobile computing device at the live event;
detecting, by the first mobile computing device at the live event, a voice audio signal via a microphone of the first mobile computing device at the live event;
in response to detecting the voice audio signal, adjusting, by the first mobile computing device at the live event, a volume of the playback of the live audio stream to a decreased volume; and
transmitting, by the first mobile computing device at the live event, the voice audio signal to a second mobile computing device at the live event via the wireless network.

2. The computerized method of claim 1, wherein the first mobile computing device is configured to receive the data representation of the live audio signal corresponding to the live event from an audio server computing device via the wireless network.

3. The computerized method of claim 1, further comprising:
detecting, by the first mobile computing device at the live event, a cessation of the voice audio signal via the microphone of the first mobile computing device at the live event.

4. The computerized method of claim 3, further comprising:
in response to detecting the cessation of the voice audio signal, adjusting, by the first mobile computing device at the live event, the volume of the playback of the live audio stream to an initial volume.

5. The computerized method of claim 1, further comprising:
transmitting, by the first mobile computing device at the live event, the voice audio signal to a third mobile computing device at the live event via the wireless network.

6. The computerized method of claim 1, further comprising:
transmitting, by the first mobile computing device at the live event, the voice audio signal to a fourth mobile computing device outside of a geographical area corresponding to the live event.

7. A computerized method for real-time voice communication between a plurality of mobile computing devices at a live event, the method comprising:
receiving, by a first mobile computing device at a live event, a data representation of a live audio signal corresponding to the live event via a wireless network;
processing, by the first mobile computing device at the live event, the data representation of the live audio signal into a live audio stream;
initiating, by the first mobile computing device at the live event, playback of the live audio stream via a headphone communicatively coupled to the first mobile computing device at the live event;
receiving, by the first mobile computing device at the live event, a voice audio signal from a second mobile computing device at the live event via the wireless network;
in response to receiving the voice audio signal, adjusting, by the first mobile computing device at the live event, a volume of the playback of the live audio stream to a decreased volume; and
initiating, by the first mobile computing device at the live event, playback of the voice audio signal via the headphone communicatively coupled to the first mobile computing device at the live event.

8. The computerized method of claim 7, wherein the first mobile computing device is configured to receive the data representation of the live audio signal corresponding to the live event from an audio server computing device via the wireless network.

9. The computerized method of claim 7, further comprising:
detecting, by the first mobile computing device at the live event, a cessation of the voice audio signal via the wireless network.

10. The computerized method of claim 9, further comprising:
in response to detecting the cessation of the voice audio signal, adjusting, by the first mobile computing device at the live event, the volume of the playback of the live audio stream to an initial volume.

11. A system for real-time voice communication between a plurality of mobile computing devices at a live event, the system comprising:
a first mobile computing device communicatively coupled to a second mobile computing device over a wireless network, the first mobile computing device configured to:
receive a first data representation of a live audio signal corresponding to the live event via the wireless network;
process the first data representation of the live audio signal into a live audio stream;
initiate playback of the live audio stream via a first headphone communicatively coupled to the first mobile computing device at the live event;
detect a first voice audio signal via a microphone of the first mobile computing device at the live event;
in response to detecting the first voice audio signal, adjust a first volume of the playback of the live audio stream to a decreased volume; and
transmit the first voice audio signal to the second mobile computing device at the live event via the wireless network; and
the second mobile computing device configured to:
receive a second data representation of the live audio signal corresponding to the live event via the wireless network;
process the second data representation of the live audio signal into the live audio stream;
initiate playback of the live audio stream via a second headphone communicatively coupled to the second mobile computing device at the live event;
receive the first voice audio signal from the first mobile computing device at the live event via the wireless network;
in response to receiving the first voice audio signal, adjust a second volume of the playback of the live audio stream to the decreased volume; and
initiate playback of the first voice audio signal via the second headphone communicatively coupled to the second mobile computing device at the live event.

12. The system of claim 11, wherein the first mobile computing device is configured to receive the first data representation of the live audio signal corresponding to the live event from an audio server computing device via the wireless network and the second mobile computing device is configured to receive the second data representation of the live audio signal corresponding to the live event from the audio server computing device via the wireless network.

13. The system of claim 11, wherein the first mobile computing device is further configured to:
detect a cessation of the first voice audio signal via the microphone of the first mobile computing device at the live event.

14. The system of claim 13, wherein the first mobile computing device is further configured to:
in response to detecting the cessation of the first voice audio signal, adjust the first volume of the playback of the live audio stream to an initial volume.

15. The system of claim 11, wherein the first mobile computing device is further configured to:
transmit the first voice audio signal to a third mobile computing device at the live event via the wireless network.

16. The system of claim 11, wherein the first mobile computing device is further configured to:
transmit the first voice audio signal to a fourth mobile computing device outside of a geographical area corresponding to the live event.

17. The system of claim 11, wherein the second mobile computing device is further configured to:
detect a cessation of the first voice audio signal via the wireless network.

18. The system of claim 17, wherein the second mobile computing device is further configured to:
in response to detecting the cessation of the first voice audio signal, adjust the second volume of the playback of the live audio stream to the initial volume.

19. The system of claim 11, wherein the second mobile computing device is further configured to:
receive a second voice audio signal from a third mobile computing device at the live event via the wireless network.

20. The system of claim 11, wherein the second mobile computing device is further configured to:
receive a second voice audio signal from a fourth mobile computing device outside of a geographical area corresponding to the live event.
